(19) United States
(12) Patent Application Publication
(10) Pub. No.: US 2022/0172661 A1
(43) Pub. Date: Jun. 2, 2022

(54) DISPLAY DRIVING APPARATUS

(71) Applicant: LX SEMICON CO., LTD., Daejeon (KR)

(72) Inventors: Jong Suk LEE, Daejeon (KR); Young Bok KIM, Daejeon (KR)

(21) Appl. No.: 17/537,752

(22) Filed: Nov. 30, 2021

(30) Foreign Application Priority Data
Dec. 1, 2020 (KR) 10-2020-0165520

(51) Int. Cl. G09G 3/20

(52) U.S. Cl. CPC G09G 3/20; G09G 2310/08; G09G 2330/021; G09G 2300/0408

(57) ABSTRACT

There is disclosed a display driving apparatus configured to drive a display device for displaying an image, the display driving apparatus including a source driver integrated circuit (IC) configured to convert image data into a source signal, and an energy harvesting apparatus configured to convert radio frequency (RF) energy into electrical energy and supply the electrical energy to the source driver IC, wherein the energy harvesting apparatus includes an RF energy converter configured to convert the RF energy to output an energy harvesting current, and an energy storage configured to receive the energy harvesting current, store power, and output a first auxiliary voltage that is a voltage generated due to the stored power, wherein the RF energy converter and the energy storage are located on the source driver IC.

### CROSS-REFERENCE TO RELATED APPLICATIONS

This application claims the benefit of the Korean Patent Applications No. 10-2020-0165520 filed on Dec. 1, 2020 which are hereby incorporated by reference as if fully set forth herein.

### FIELD OF THE INVENTION

The present specification relates to a display driving apparatus.

### BACKGROUND

Representative examples of a display device for displaying an image include a liquid crystal display (LCD) using liquid crystals, an organic light-emitting diode (OLED) display using an OLED, and the like. A technique for reducing the power consumption of the display device has been developed.

However, it is difficult to reduce power essentially consumed to perform each function in a display panel and a display driving apparatus constituting the display device.

### SUMMARY

The present disclosure is directed to providing a display driving apparatus allowing power supplied from the outside to be reduced by supplying auxiliary power generated through an energy harvesting apparatus.

According to an aspect of the present disclosure, there is provided a display driving apparatus configured to drive a display device for displaying an image, the display driving apparatus including a source driver integrated circuit (IC) configured to convert image data into a source signal, and an energy harvesting apparatus configured to convert radio frequency (RF) energy into electrical energy and supply the electrical energy to the source driver IC, wherein the energy harvesting apparatus includes an RF energy converter configured to convert the RF energy to output an energy harvesting current, and an energy storage configured to receive the energy harvesting current, store power, and output a first auxiliary voltage that is a voltage generated due to the stored power, wherein the RF energy converter and the energy storage are located on the source driver IC.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a diagram illustrating a configuration of a display device including a display driving apparatus according to one embodiment of the present disclosure;

FIG. 2 is a diagram illustrating a structure of a source driver integrated circuit (IC) and an energy harvesting apparatus according to one embodiment of the present disclosure;

FIG. 3 is a view illustrating a configuration of the energy harvesting apparatus according to one embodiment of the present disclosure;

FIG. 4 is a view schematically illustrating a structure of an antenna part of a radio frequency (RF) energy converter according to one embodiment of the present disclosure;

FIG. 5 is a diagram illustrating a circuit structure of an RF-to-direct current (RF-DC) rectifier circuit part according to one embodiment of the present disclosure; and

FIG. 6 is a flowchart illustrating an energy harvesting process according to one embodiment of the present disclosure.

### DETAILED DESCRIPTION

In the specification, it should be noted that like reference numerals already used to denote like elements in other drawings are used for elements wherever possible. In the following description, when a function and a configuration known to those skilled in the art are irrelevant to the essential configuration of the present disclosure, their detailed descriptions will be omitted. The terms described in the specification should be understood as follows.

Advantages and features of the present disclosure, and implementation methods thereof will be clarified through following embodiments described with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. Further, the present disclosure is only defined by scopes of claims.

A shape, a size, a ratio, an angle, and a number disclosed in the drawings for describing embodiments of the present disclosure are merely an example, and thus, the present disclosure is not limited to the illustrated details. Like reference numerals refer to like elements throughout. In the following description, when the detailed description of the relevant known function or configuration is determined to unnecessarily obscure the important point of the present disclosure, the detailed description will be omitted.

In a case where ‘comprise’, ‘have’, and ‘include’ described in the present specification are used, another part may be added unless ‘only˜’ is used. The terms of a singular form may include plural forms unless referred to the contrary.

In construing an element, the element is construed as including an error range although there is no explicit description.

In describing a time relationship, for example, when the temporal order is described as ‘after˜’, ‘subsequent˜’, ‘next˜’, and ‘before˜’, a case which is not continuous may be included unless ‘just’ or ‘direct’ is used.

It will be understood that, although the terms “first”, “second”, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

The term “at least one” should be understood as including any and all combinations of one or more of the associated listed items. For example, the meaning of “at least one of a first item, a second item, and a third item” denotes the combination of all items proposed from two or more of the first item, the second item, and the third item as well as the first item, the second item, or the third item.

Features of various embodiments of the present disclosure may be partially or overall coupled to or combined with each other, and may be variously inter-operated with each other and driven technically as those skilled in the art can sufficiently understand. The embodiments of the present disclosure may be carried out independently from each other, or may be carried out together in co-dependent relationship.

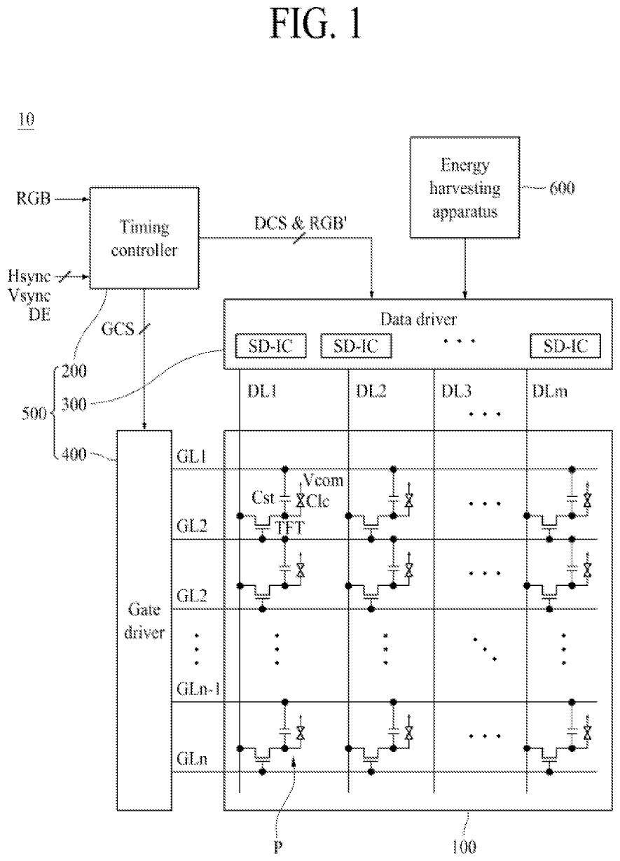

Hereinafter, a display device according to an embodiment of the present disclosure will be described in detail with reference to FIG. 1.

FIG. 1 is a diagram illustrating a configuration of a display device including a display driving apparatus according to one embodiment of the present disclosure. As shown in FIG. 1, a display device 10 includes a display panel 100 and a display driving apparatus 500, and the display driving apparatus 500 includes a timing controller 200, a data driver 300, a gate driver 400, and an energy harvesting apparatus 600.

The display panel 100 includes a plurality of gate lines GL1 to GLn and a plurality of data lines DL1 to DLm, which are arranged to intersect each other and define a plurality of pixel regions, and a pixel P provided in each of the plurality of pixel regions. The plurality of gate lines GL1 to GLn may be arranged in a transverse direction and the plurality of data lines DL1 to DLm may be arranged in a longitudinal direction, but the present disclosure is not necessarily limited thereto.

The display panel 100 may be a liquid crystal display (LCD) panel. When the display panel 100 is an LCD panel, the display panel 100 includes thin-film transistors (TFTs) and liquid crystal cells connected to the TFTs, which are formed in the pixel regions (P) defined by the plurality of gate lines GL1 to GLn and the plurality of data lines DL1 to DLm.

The TFT transmits a data signal supplied through the data lines DL1 to DLm to the liquid crystal cell in response to a scan pulse supplied through the gate lines GL1 to GLn.

The liquid crystal cell is composed of a common electrode and a sub-pixel electrode, which is connected to the TFT, facing each other with a liquid crystal therebetween, and thus may be equivalently expressed as a liquid crystal capacitor Clc. The liquid crystal cell includes a storage capacitor Cst connected to the gate line of a previous stage in order to maintain a voltage corresponding to a source signal charged in the liquid crystal capacitor Clc until a voltage corresponding to a next source signal is charged.

Meanwhile, the pixel regions of the display panel 100 may include red (R), green (G), blue (B), and white (W) subpixels. Each of the subpixels may be repeatedly formed in a row direction or formed in a matrix form of 2×2. In this case, a color filter corresponding to each color is disposed in each of the red (R), green (G), and blue (B) subpixels, but a separate color filter is not disposed in the white (W) subpixel. The red (R), green (G), blue (B), and white (W) subpixels may be formed to have the same area ratio, but may also be formed to have different area ratios.

Although the display panel 100 is described as being an LCD panel, the display panel 100 may be an organic light-emitting diode (OLED) display panel in which an OLED is formed in each pixel region.

The timing controller 200 receives various timing signals including a vertical synchronization signal Vsync, a horizontal synchronization signal Hsync, a data enable signal DE, a clock signal CLK, and the like from an external system (not shown), and generates a data control signal DCS for controlling the data driver 300 and a gate control signal GCS for controlling the gate driver 400. In addition, the timing controller 200 receives an image signal RGB from the external system, converts the received image signal RGB into an image signal RGB′ in a form that can be processed by the data driver 300, and outputs the converted image signal RGB′.

The data driver 300 converts the aligned image data RGB′ into a source signal according to the data control signal DCS generated by the timing controller 200. The data control signal DCS may include a source start pulse SSP, a source sampling clock SSC, a source output enable signal SOE, and the like. Here, the source start pulse controls a data sampling start timing of a signal converter. The source sampling clock is a clock signal which controls a sampling timing of data in each of source driver integrated circuits (ICs). The source output enable signal controls an output timing of the signal converter of each of the source driver ICs. That is, the data driver 300 converts the aligned image data RGB′ into the source signal according to the source start pulse, the source sampling clock, and the source output enable signal and outputs the source signals corresponding to one horizontal line to the data lines every one horizontal period at which the gate signals are supplied to the gate lines. Here, the signal converter may receive a gamma voltage from a gamma voltage generator (not shown) and convert the aligned image data RGB′ into the source signal using the gamma voltage. To this end, the data driver 300 includes n source driver ICs SD-IC.

The gate driver 400 outputs the gate signals, which are synchronized with the source signals generated by the data driver 300, to the gate lines in response to the gate control signal GCS generated by the timing controller 200. The gate control signal GCS may include a gate start pulse GSP, a gate shift clock GSC, a gate output enable signal, and the like. Here, the gate start pulse controls an operation start timing of m gate driver ICs (not shown) that configure the gate driver 400. The gate shift clock controls a shift timing of a scan signal (a gate pulse), which is a clock signal commonly input to the one or more gate driver ICs. The gate output enable signal designates timing information of one or more gate driver ICs. That is, the gate driver 400 outputs the gate signals, which are synchronized with the source signals according to the gate start pulse, the gate shift clock, and the gate output enable signal that are generated by the timing controller 200, to the gate lines.

The gate driver 400 includes a gate shift register circuit, a gate level shifter circuit, and the like. In this case, the gate shift register circuit may be formed directly on a TFT array substrate of the display panel 100 by a gate-in-panel (GIP) process. In this case, the gate driver 400 supplies the gate start pulse and the gate shift clock signal to the gate shift register circuit that is formed on the TFT array substrate by a GIP process.

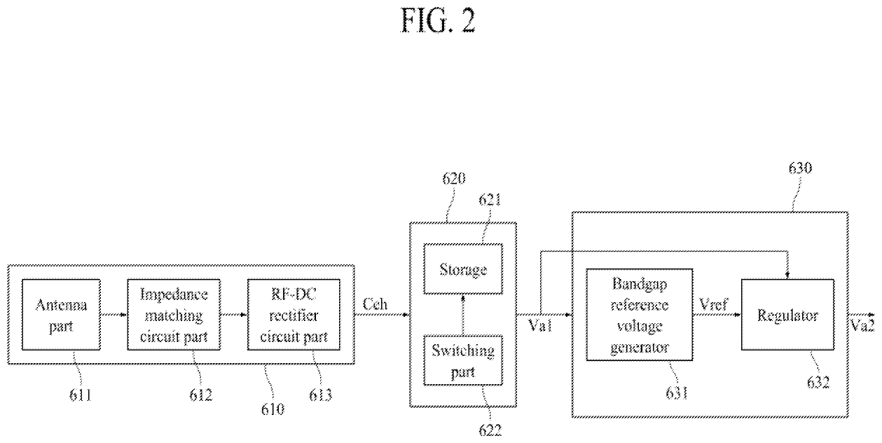

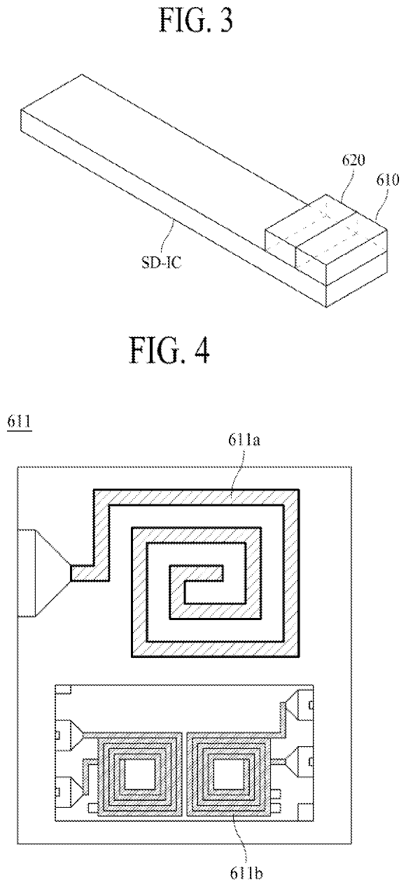

According to one embodiment of the present disclosure, the energy harvesting apparatus 600 converts radio frequency (RF) energy into electrical energy and supplies the electrical energy to the data driver 300. The energy harvesting apparatus 600 includes an RF energy converter 610, an energy storage 620, and a voltage stabilizer 630. The energy harvesting apparatus 600 according to one embodiment of the present disclosure will be described below in detail with reference to FIGS. 2 and 3.

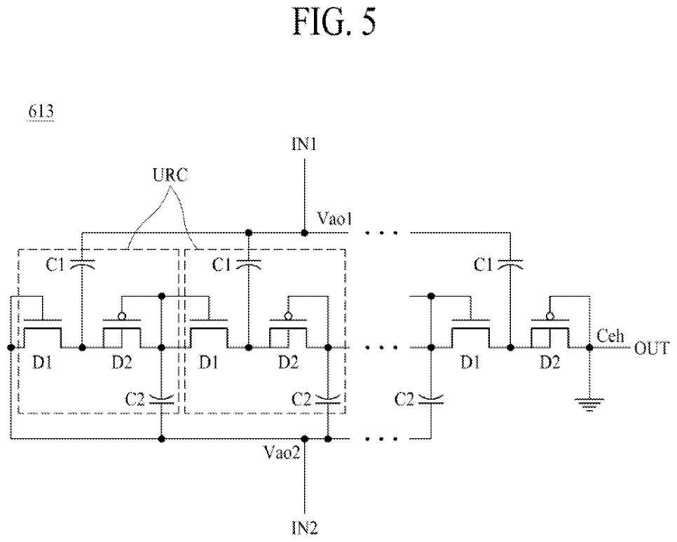

Hereinafter, the energy harvesting apparatus according to the present disclosure will be described in detail with reference to FIGS. 2 to 5. FIG. 2 is a diagram schematically illustrating a structure of the source driver IC and the energy harvesting apparatus according to one embodiment of the present disclosure, and FIG. 3 is a view illustrating a configuration of the energy harvesting apparatus according to one embodiment of the present disclosure. FIG. 4 is a view schematically illustrating a structure of an antenna part of the RF energy converter according to one embodiment of the present disclosure, and FIG. 5 is a diagram illustrating a circuit structure of an RF-to-direct current (RF-DC) rectifier circuit part according to one embodiment of the present disclosure.

The energy harvesting apparatus 600 converts ambient RF energy into electrical energy and outputs the converted electrical energy. According to one embodiment of the present disclosure, the energy harvesting apparatus 600 converts ambient RF energy into electrical energy, and outputs the converted electrical energy to the source driver IC SD-IC.

As shown in FIGS. 2 and 3, the energy harvesting apparatus 600 according to one embodiment of the present disclosure includes the RF energy converter 610, the energy storage 620, and the voltage stabilizer 630.

The RF energy converter 610 collects ambient RF energy, converts the collected RF energy into electrical energy, and outputs the electrical energy. Specifically, the RF energy converter 610 collects ambient RF energy, and converts the collected RF energy to output an energy harvesting current Ceh to the energy storage 620. According to one embodiment of the present disclosure, since the RF energy converter 610 is directly connected to a storage 621 of the energy storage 620, which will be described below, the energy harvesting current Ceh is input to the storage 621 of the energy storage 620 without passing through a separate rectifier circuit.

The RF energy converter 610 includes an antenna part 611, an impedance matching circuit part 612, and an RF-DC rectifier circuit part 613.

The antenna part 611 collects RF energy generated due to external electromagnetic radiation in the ambient environment and generates an antenna output voltage corresponding to the collected RF energy. At this point, the antenna output voltage is an alternating current (AC) voltage.

The antenna part 611 may include a plurality of antennas for collecting RF energy of different frequencies to increase the total amount of RF energy collected by the antenna part 611. The antenna part 611 may include a plurality of antennas each for collecting RF energy corresponding to each frequency band. Specifically, as shown in FIG. 4, the antenna part 611 may include a first antenna 611a and a second antenna 611b for collecting RF energy of different frequency bands. Each of the antennas may have a smaller area as a receiving frequency band increases. For example, the antenna part 611 may include the first antenna 611a configured to collect RF energy of a frequency band of 1.1 GHz and the second antenna 611b configured to collect RF energy of a frequency band of 1.8 GHz, and the first antenna 611a may have a larger area than the second antenna 611b.

According to one embodiment of the present disclosure, the antenna part 611 may be disposed on the source driver IC SD-IC in the form of a film. Accordingly, the area and volume of the energy harvesting apparatus 600 configured to supply electrical energy to the source driver IC SD-IC may be reduced so that the source driver IC SD-IC and the energy harvesting apparatus 600 may be light in weight.

The impedance matching circuit part 612 allows the impedance of the antenna part 611 to be matched to that of the RF-DC rectifier circuit part 613, thereby improving the reception efficiency of the RF energy collected by the antenna part 611.

The RF-DC rectifier circuit part 613 rectifies an impedance-matched antenna output voltage to output the energy harvesting current Ceh to the energy storage 620. Specifically, the RF-DC rectifier circuit part 613 receives and rectifies a first antenna output voltage Vao1, which is the antenna output voltage output from the antenna part 611, and a second antenna output voltage Vao2, which is an inverted voltage of the antenna output voltage, to output the energy harvesting current Ceh. For example, as shown in FIG. 5, the RF-DC rectifier circuit part 613 receives the first antenna output voltage Vao1 through a first input terminal IN1 and receives the second antenna output voltage Vao2 through a second input terminal IN2, and rectifies the received first and second antenna output voltages Vao1 and Vao2 to output the energy harvesting current Ceh.

The RF-DC rectifier circuit part 613 according to one embodiment of the present disclosure receives the first antenna output voltage Vao1, which is the antenna output voltage, and the second antenna output voltage Vao2, which is a voltage inverted from the antenna output voltage, and thus does not include a separate oscillator including a clock.

The RF-DC rectifier circuit part 613 according to one embodiment of the present disclosure rectifies the antenna output voltage using a plurality of diodes D1 and D2 and a plurality of capacitors C1 and C2. Specifically, the RF-DC rectifier circuit part 613 includes one or more unit rectifier circuits URC each including a first diode D1, which is an NMOS transistor, a second diode D2, which is a PMOS transistor, a first capacitor Cl connected to an output terminal of the first diode D1, and a second capacitor C2 connected to an output terminal of the second diode D2. Accordingly, the RF-DC rectifier circuit part 613 may be configured by linearly connecting the one or more unit rectifier circuits URC. Accordingly, the RF-DC rectifier circuit part 613 rectifies the first antenna output voltage Vao1 and the second antenna output voltage Vao2 through the one or more unit rectifier circuits URC to output the energy harvesting current Ceh.

The RF-DC rectifier circuit part 613 includes the first input terminal IN1 through which the first antenna output voltage Vao1 is received, the second input terminal IN2, through which the second antenna output voltage Vao2 is received, the above-described one or more unit rectifier circuits URC, and an output terminal OUT connected to the one or more unit rectifier circuits URC and through which the energy harvesting current Ceh is output. At this point, as shown in FIG. 5, the first input terminal IN1 is connected to the output terminal of the first diode D1 and an input terminal of the second diode D2 through the first capacitor C1, and the second input terminal IN2 is connected to an input terminal and a control terminal of the first diode D1 and connected to the output terminal and a control terminal of the second diode D2 through the second capacitor C2.

The RF-DC rectifier circuit part 613 according to one embodiment of the present disclosure includes the first diode D1, which is an NMOS transistor having a high threshold voltage and low turn-on resistance, and the second diode D2, which is a PMOS transistor having a low threshold voltage and high turn-on resistance, and thus outputs a stable and high voltage as compared to a rectifier circuit configured with only the NMOS transistor and a rectifier circuit configured with only the PMOS transistor.

The energy storage 620 receives the energy harvesting current Ceh, and accordingly, when a first auxiliary voltage Va1, which is a voltage generated due to power stored in the energy storage 620, is greater than or equal to a usable voltage, the first auxiliary voltage Va1 is output to the voltage stabilizer 630.

As the energy harvesting current Ceh is input to the energy storage 620, the amount of power stored in the energy storage 620 increases to increase the first auxiliary voltage Va1 generated due to the stored power, and when the first auxiliary voltage Va1 is greater than or equal to the usable voltage, the energy storage 620 outputs the first auxiliary voltage Va1.

According to one embodiment of the present disclosure, the energy storage 620 is disposed on the source driver IC SD-IC in the form of a film. As such, the energy storage 620 may be integrally configured with the source driver IC SD-IC so that the area and volume occupied by the energy storage 620 may be reduced.

Since the energy harvesting apparatus 600 according to one embodiment of the present disclosure includes the RF-DC rectifier circuit part 613, the energy storage 620 is directly connected to the RF energy converter 610. Accordingly, since the energy storage 620 directly receives the energy harvesting current Ceh, which is not rectified, output from the RF energy converter 610, the first auxiliary voltage Va1 output from the energy storage 620 may include noise, and thus the first auxiliary voltage Va1 is rectified through the voltage stabilizer 630, which will be described below.

The energy storage 620 may have a smaller area than the source driver IC SD-IC and may be integrally configured with the source driver IC SD-IC on the source driver IC SD-IC. For example, the energy storage 620 may have a width less than or equal to that of the source driver IC SD-IC, and may have a length less than that of the source driver IC SD-IC. Accordingly, the source driver IC SD-IC and the energy harvesting apparatus 600 may be reduced in area and volume and light in weight.

The energy storage 620 includes the storage 621 and a switching part 622.

The storage 621 receives the energy harvesting current Ceh, stores power, and outputs the first auxiliary voltage Va1 generated due to the stored power.

The switching part 622 controls the storage 621 to output the first auxiliary voltage Va1 from the storage 621 to the voltage stabilizer 630 when the first auxiliary voltage Va1, which is a voltage generated due to the power stored in the storage 621, is greater than or equal to a usable voltage.

The voltage stabilizer 630 rectifies the first auxiliary voltage Va1 output from the energy storage 620 to output a second auxiliary voltage Va2. In detail, since the energy storage 620 receives the energy harvesting current Ceh, which is not rectified, the first auxiliary voltage Va1 output from the energy storage 620 may include noise. Accordingly, the voltage stabilizer 630 rectifies the first auxiliary voltage Va1 output from the energy storage 620, and outputs the second auxiliary voltage Va2, which is obtained by rectifying the first auxiliary voltage Va1, to the source driver IC SD-IC.

Although not shown in the drawings, according to one embodiment of the present disclosure, the voltage stabilizer 630 may be disposed on the source driver IC SD-IC to be integrally configured with the source driver IC SD-IC. Accordingly, the energy harvesting apparatus 600 and the source driver IC SD-IC may be reduced in area and volume and light in weight.

Alternatively, according to another embodiment of the present disclosure, the voltage stabilizer 630 may be embedded in the source driver IC SD-IC. Accordingly, the energy harvesting apparatus 600 and the source driver IC SD-IC may be reduced in area and volume and light in weight.

Referring to FIG. 3 again, the voltage stabilizer 630 includes a bandgap reference voltage generator 631 and a regulator 632.

The bandgap reference voltage generator 631 generates a bandgap reference voltage Vref that maintains a constant level even when the temperature changes, and provides the bandgap reference voltage Vref to the regulator 632, which will be described below.

According to one embodiment of the present disclosure, since the voltage stabilizer 630 outputs the second auxiliary voltage Va2 using the reference voltage Vref generated by the bandgap reference voltage generator 631, the voltage stabilizer 630 may supply the second auxiliary voltage Va2 of a more stable level to the source driver IC SD-IC.

The regulator 632 outputs the second auxiliary voltage Va2 corresponding to the first auxiliary voltage Va1 to the source driver IC SD-IC using the reference voltage Vref generated from the bandgap reference voltage generator 631.

In the voltage stabilizer 630 according to one embodiment of the present disclosure, a DC-DC converter including an inductor is replaced with the bandgap reference voltage generator 631 and the regulator 632 so that power loss caused by the inductor of the DC-DC converter may be prevented, and complex analog circuits are replaced with the bandgap reference voltage generator 631 and the regulator 632, thereby reducing a circuit area of the voltage stabilizer 630.

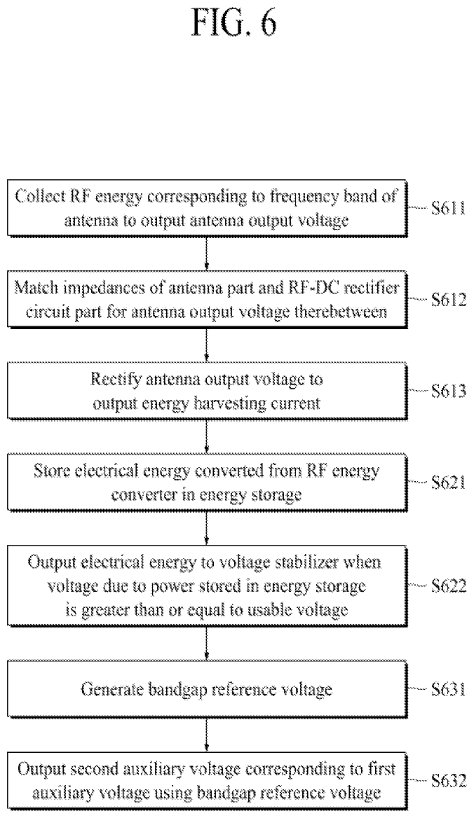

Hereinafter, a process of energy harvesting of the display driving apparatus according to the present disclosure will be described in detail with reference to FIG. 6. FIG. 6 is a flowchart illustrating an energy harvesting process of the display driving apparatus according to one embodiment of the present disclosure.

Operations S611 to S613 are performed by the RF energy converter 610, operations S621 and S622 are performed by the energy storage 620, and operations S631 and S632 are performed by the voltage stabilizer 630.

First, the energy harvesting apparatus 600 collects RF energy corresponding to a frequency band of the antenna to output an antenna output voltage to the impedance matching circuit part 612 (S611).

Thereafter, the energy harvesting apparatus 600 matches impedances of the antenna part 611 and the RF-DC rectifier circuit part 613 for the antenna output voltage therebetween in order to improve the reception efficiency of the RF energy (S612).

Thereafter, the energy harvesting apparatus 600 rectifies the antenna output voltage, which is an AC voltage, to output an energy harvesting current Ceh to the energy storage 620 (S613).

Thereafter, the energy harvesting apparatus 600 stores electrical energy converted by the RF energy converter 610 in the energy storage 620 (S621).

Specifically, the energy harvesting apparatus 600 stores the energy harvesting current Ceh, which is converted from the RF energy by the RF energy converter 610, in the energy storage 620.

Thereafter, the energy harvesting apparatus 600 outputs the electrical energy stored in the energy storage 620 to the voltage stabilizer 630 when a voltage generated due to the amount of the power stored in the energy storage 620 is greater than or equal to a usable voltage (S622). Specifically, when the first auxiliary voltage Va1, which is a voltage generated due to the amount of the power stored in the energy storage 620, is greater than or equal to the usable voltage, the switching part 622 controls the storage 621 to output the stored power.

Thereafter, the energy harvesting apparatus 600 generates a reference voltage Vref that maintains a constant level even when the temperature changes (S631).

Thereafter, the energy harvesting apparatus 600 outputs a second auxiliary voltage Va2 corresponding to the first auxiliary voltage Va1 to the source driver IC SD-IC using the reference voltage Vref (S632).

A display driving apparatus according to the present disclosure can receive electrical energy converted from radio frequency (RF) energy as an auxiliary power source so that the amount of power supplied from the outside can be reduced.

Further, a display driving apparatus according to the present disclosure includes an NMOS transistor having a high threshold voltage and low turn-on resistance, and a PMOS transistor having a low threshold voltage and high turn-on resistance, and thus can rectify to a stable and high voltage as compared with an RF-DC rectifier circuit configured with only the NMOS transistor and an RF-DC rectifier circuit configured with only the PMOS transistor.

Further, a display driving apparatus according to the present disclosure can prevent power loss caused by an inductor of a DC-DC converter by replacing the DC-DC converter, which is generally used to rectify and includes an inductor, with a bandgap reference voltage generator and a regulator, and reduce an area of a circuit used to rectify.

Further, in a display driving apparatus according to the present disclosure, an RF energy converter can be directly connected to an energy storage by including an RF-DC rectifier circuit part configured to rectify electrical energy converted from RF energy.

It will be apparent to those skilled in the art that various changes and modifications may be made without departing from the spirit and scope of the disclosure.

In addition, at least a part of the methods described herein may be implemented using one or more computer programs or components. These components may be provided as a series of computer instructions through a computer-readable medium or a machine-readable medium, which includes volatile and non-volatile memories. The instructions may be provided as software or firmware and may be entirely or partially implemented in a hardware configuration such as application specific integrated circuits (ASICs), field programmable gate arrays (FPGAs), digital signal processors (DSPs), or other similar devices. The instructions may be configured to be executed by one or more processors or other hardware components, and when one or more processors or other hardware components execute the series of computer instructions, one or more processors or other hardware components may entirely or partially perform the methods and procedures disclosed herein.

Therefore, it should be understood that the above-described embodiments are not restrictive but illustrative in all aspects. The scope of the present disclosure is defined by the appended claims rather than the detailed description, and it should be construed that all alternations or modifications derived from the meaning and scope of the appended claims and the equivalents thereof fall within the scope of the present disclosure.

### DESCRIPTION OF REFERENCE NUMERALS

10: display device
100: display panel
500: display driving apparatus
200: timing controller
300: data driver
400: gate driver
600: energy harvesting apparatus.

What is claimed is:

1. A display driving apparatus configured to drive a display device for displaying an image, the display driving apparatus comprising:
a source driver integrated circuit (IC) configured to convert image data into a source signal; and
an energy harvesting apparatus configured to convert radio frequency (RF) energy into electrical energy and supply the electrical energy to the source driver IC,
wherein the energy harvesting apparatus includes:
an RF energy converter configured to convert the RF energy to output an energy harvesting current; and
an energy storage configured to receive the energy harvesting current, store power, and output a first auxiliary voltage that is a voltage generated due to the stored power,
wherein the RF energy converter and the energy storage are located on the source driver IC.

2. The display driving apparatus of claim 1, further comprising a voltage stabilizer configured to generate a reference voltage and output a second auxiliary voltage corresponding to the first auxiliary voltage to the source driver IC using the reference voltage.

3. The display driving apparatus of claim 1, further comprising a voltage stabilizer configured to output a second auxiliary voltage corresponding to the first auxiliary voltage to the source driver IC,
wherein the voltage stabilizer includes:
a bandgap reference voltage generator configured to generate a reference voltage that maintains a constant level in response to temperature changes; and
a regulator configured to output the second auxiliary voltage corresponding to the first auxiliary voltage to the source driver IC using the reference voltage.

4. The display driving apparatus of claim 1, further comprising a voltage stabilizer configured to output a second auxiliary voltage corresponding to the first auxiliary voltage to the source driver IC,
wherein the voltage stabilizer is located on the source driver IC.

5. The display driving apparatus of claim 1, further comprising a voltage stabilizer configured to output a second auxiliary voltage corresponding to the first auxiliary voltage to the source driver IC,
wherein the voltage stabilizer is embedded in the source driver IC.

6. The display driving apparatus of claim 1,
wherein the RF energy converter includes:
an antenna part including an antenna configured to collect the RF energy to output an antenna output voltage; and
an RF-to-direct current (RF-DC) rectifier circuit part configured to rectify the antenna output voltage to output the energy harvesting current.

7. The display driving apparatus of claim 1,
wherein the RF energy converter includes:
an antenna part including an antenna configured to collect the RF energy to output an antenna output voltage; and
an RF-DC rectifier circuit part configured to rectify the antenna output voltage using a first diode, which is an N-type metal-oxide-semiconductor (NMOS) transistor, a second diode, which is a P-type metal-oxide-semiconductor (PMOS) transistor, and a capacitor to output the energy harvesting current.

8. The display driving apparatus of claim 1,
wherein the RF energy converter includes:
an antenna part including an antenna configured to collect the RF energy to output an antenna output voltage; and
an RF-DC rectifier circuit part configured to rectify the antenna output voltage to output the energy harvesting current,
wherein the RF-DC rectifier circuit part includes one or more unit rectifier circuits including a first diode, which is an NMOS transistor, a second diode, which is a PMOS transistor, and two capacitors,
wherein the one or more unit rectifier circuits are linearly connected to each other, and rectify the antenna output voltage to output the energy harvesting current.

9. The display driving apparatus of claim 8, wherein the unit rectifier circuits receive and rectify a first antenna output voltage, which is the antenna output voltage, and a second antenna output voltage, which is an inverted voltage of the antenna output voltage, to output the energy harvesting current.

10. The display driving apparatus of claim 1,
wherein the RF energy converter includes:
an antenna part including an antenna configured to collect the RF energy to output an antenna output voltage; and
an RF-DC rectifier circuit part configured to rectify the antenna output voltage to output the energy harvesting current,
wherein the RF-DC rectifier circuit part includes:
a first input terminal through which a first antenna output voltage, which is the antenna output voltage, is received;
a second input terminal through which a second antenna output voltage, which is an inverted voltage of the antenna output voltage, is received;
one or more unit rectifier circuits configured to receive the first antenna output voltage and the second antenna output voltage, and rectify the first and second antenna output voltages using a first diode, which is an NMOS transistor, a second diode, which is a PMOS transistor, a first capacitor, and a second capacitor to output the energy harvesting current; and
an output terminal connected to the one or more unit rectifier circuits and through which the energy harvesting current is output.

11. The display driving apparatus of claim 10, wherein,
in the unit rectifier circuits, the first diode and the second diode are alternately and linearly connected,
the first input terminal is connected to an output terminal of the first diode and an input terminal of the second diode through the first capacitor, and
the second input terminal is connected to an input terminal and a control terminal of the first diode, and is connected to an output terminal and a control terminal of the second diode through the second capacitor.

12. The display driving apparatus of claim 1, wherein the energy storage is directly connected to the RF energy converter, receives the energy harvesting current, and outputs the first auxiliary voltage when the first auxiliary voltage, which is a voltage generated due to the energy harvesting current, is greater than or equal to a usable voltage.

13. The display driving apparatus of claim 1, wherein
the RF energy converter includes an antenna part including an antenna configured to collect RF energy of different frequency bands to output an antenna output voltage that is an alternating current (AC) voltage,
wherein the energy storage and the antenna part are provided in the form of a film.

14. The display driving apparatus of claim 1, wherein
the RF energy converter includes an antenna part including an antenna configured to collect RF energy of different frequency bands to output an antenna output voltage that is an AC voltage,
wherein the energy storage and the antenna part have a smaller area than the source driver IC.
